(19) United States
(12) Patent Application Publication
(10) Pub. No.: US 2024/0008545 A1
(43) Pub. Date: Jan. 11, 2024

(54) AEROSOL-GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/023,662

(22) PCT Filed: Jun. 22, 2022
(86) PCT No.: PCT/KR2022/008892

§ 371 Date: Feb. 27, 2023

(30) Foreign Application Priority Data
Jun. 23, 2021 (KR) 10-2021-0081228

(51) Int. Cl. A24F 40/465; A24F 40/51; H05B 6/10

(52) U.S. Cl. CPC A24F 40/465; A24F 40/51; H05B 6/105

(57) ABSTRACT

An aerosol-generating device is disclosed. The aerosol-generating device of the disclosure includes a pipe defining an insertion space; a flange comprising a through hole and coupled to the pipe at a first side of the insertion space; and a susceptor extending through the through hole such that a first end thereof extends into the insertion space; wherein a leg of the susceptor at a second end thereof is bent radially outwards and configured to engage with a retainer formed at the flange.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various researches on aerosol-generating devices have been conducted.

### DISCLOSURE OF INVENTION

### Technical Problem

It is an object of the present disclosure to solve the above and other problems.

It is another object of the present disclosure to prevent rotation of a susceptor.

It is still another object of the present disclosure to prevent the susceptor from being separated from an aerosol-generating device.

It is yet another object of the present disclosure to provide an aerosol-generating device which enables the susceptor to be easily fixed.

### Solution to Problem

In accordance with an aspect of the present disclosure for accomplishing the above objects, there is provided an aerosol-generating device including a pipe defining an insertion space; a flange comprising a through hole and coupled to the pipe at a first side of the insertion space; and a susceptor extending through the through hole such that a first end thereof extends into the insertion space; wherein a leg of the susceptor at a second end thereof is bent radially outwards and configured to engage with a retainer formed at the flange.

### Advantageous Effects of Invention

According to at least one of embodiments of the present disclosure, it is possible to provide an aerosol-generating device capable of preventing rotation of a susceptor.

According to at least one of embodiments of the present disclosure, it is possible to provide an aerosol-generating device capable of preventing the susceptor from being separated therefrom.

According to at least one of embodiments of the present disclosure, it is possible to provide an aerosol-generating device capable of allowing the susceptor to be fixed in a simple manner.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 9 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

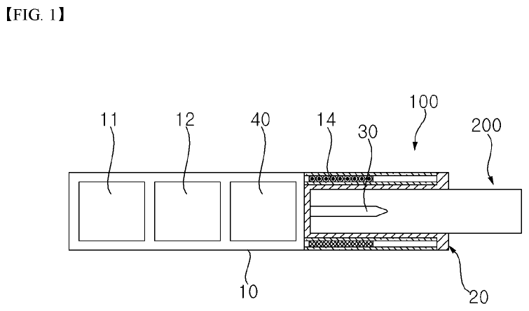

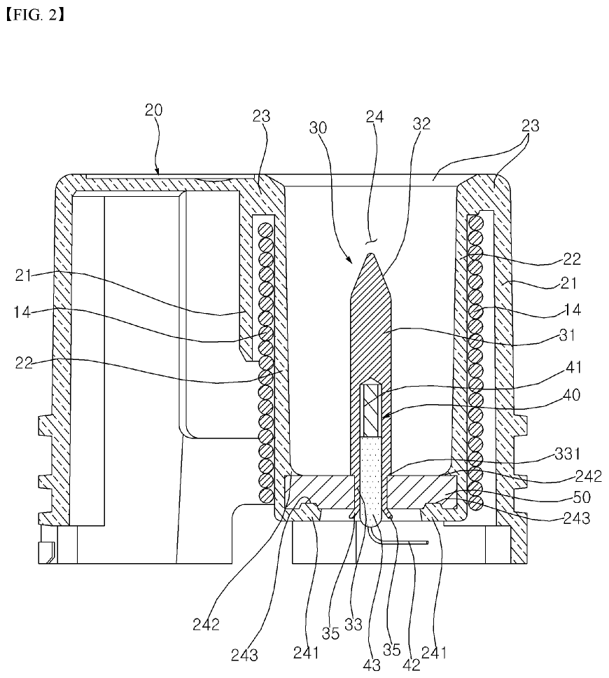

Referring to FIGS. 1 and 2, an aerosol-generating device 100 according to the present disclosure may include at least one of a battery 11, a controller 12, a sensor 40, or an induction coil 14. At least one of the battery 11, the controller 12, the sensor 40, or the induction coil 14 may be disposed in a lower body 10 of the aerosol-generating device 100.

An upper body 20 may be coupled to one end of the lower body 10, or may constitute a portion of the lower body 10. The induction coil 14 may be mounted in the upper body 20. A susceptor 30 may be mounted in the upper body 20. The upper body may have an insertion space 24 into which a stick 200 is inserted. The susceptor 30 may be disposed in the insertion space 24.

The induction coil 14 may surround the insertion space 24 in which the susceptor is disposed. The induction coil 14 may surround the susceptor 30. The susceptor 30 may be heated by a magnetic field generated by AC current flowing through the induction coil 14. The magnetic field may pass through the susceptor 30, and may generate eddy current in the susceptor 30. The current may generate heat in the susceptor 30. Alternatively, the susceptor 30 may receive current from the battery 11 and may generate heat directly, without the induction coil 14.

The stick 200 may be inserted into the insertion space 24. One end of the stick 200 may be exposed to the outside of the upper body 20. The susceptor 30 may be inserted into the stick 200 through an end of the stick 200. The stick 200 may be heated by the susceptor 30. A user may inhale air while holding the end of the stick 200 that is exposed to the outside in his/her mouth.

The battery 11 may supply power in order to operate the components of the aerosol-generating device 100. The battery 100 may supply power to at least one of the controller 12, the sensor 40, the induction coil 14, or the susceptor 30. The battery 11 may supply power required to operate a display, a motor, or the like mounted on the aerosol-generating device 100.

The controller 12 may control the overall operation of the aerosol-generating device 100. The controller 12 may control at least one of the battery 11, the induction coil 14, or the sensor 40. The controller 12 may be control the operation of the display, the motor, and the like mounted on the aerosol-generating device 100. The controller 12 may check the state of the individual components of the aerosol-generating device 100 in order to determine whether or not the aerosol-generating device 100 is operable.

The sensor 40 may sense the temperature of the susceptor 30. The sensor 40 may be disposed in the susceptor 30. The sensor 40 may be referred to as a sensing device 40.

The controller 12 may control the temperature of the induction coil 14 based on the temperature of the induction coil 14. The controller 12 may transmit information about the temperature of the induction coil 14 to a user through a user interface, based on the temperature of the induction coil 14 sensed by the sensor 40.

The upper body 20 may include at least one of an outer wall, an inner wall 22, or an upper wall 23. The inner wall 22 may define the insertion space 24. The insertion space 24 may be open toward the outside. The inner wall 22 may surround the side portion of the insertion space 24. Each of the inner wall 22 and the insertion space 24 may have the form of a cylinder. The insertion space 24 may be open at the upper and lower ends thereof, but may be covered at the lower end thereof by a flange 50. The inner wall 22 may be referred to as a pipe 22. The stick 200 may be inserted into the pipe 22.

The outer wall 21 may be disposed outside the inner wall 22. The outer wall 21 may be spaced apart from the outer circumferential surface of the inner wall 22 in a radially outward direction. A space may be formed between the outer wall 21 and the inner wall 22. The induction coil 14 may be disposed in the space formed between the outer wall 21 and the inner wall 22. The induction coil 14 may surround the inner wall 22. The upper wall 23 may connect the outer wall 21 to the inner wall 22.

The susceptor 30 may be disposed in the insertion space 24. The susceptor 30 may extend lengthwise. The susceptor 30 may include a susceptor body 31 and a susceptor head 32. The susceptor body 31 may be formed at the middle of the susceptor 30. The susceptor body 31 may have the form of a cylinder. The susceptor body 31 may be disposed in the insertion space 24. The susceptor head 32 may be formed at the upper end of the susceptor 30. The susceptor head 32 may have the form of a cone. The susceptor head 32 may be disposed in the insertion space 24. The susceptor head 32 may be directed toward one side of the insertion space 24, which is open.

The flange 50 may be coupled or fixed to the lower portion of the pipe 22. The upper surface of the flange 50 may cover the other side of the insertion space 24. The upper surface of the flange 50 may face the insertion space 24. The lower surface of the flange 50 may be opposite the upper surface of the flange 50 so as to face downwards.

A first rib 241 and a second rib 242 may project radially inwards from the inner circumferential surface of the lower portion of the pipe 22. Each of the first rib 241 and the second rib 242 may have the form of a ring. The first rib 241 may be formed at the lower end of the pipe 22. The second rib 242 may be formed at the lower portion of the pipe 22 above the first rib 241. The flange 50 may be disposed or fitted between the first rib 241 and the second rib 242.

The susceptor 30 may extend toward the insertion space 24 through the flange 50. One side of the susceptor 30 may extend through the flange 50, and may be exposed to the insertion space 24. The other side of the susceptor 30 may be exposed from the lower surface of the flange 50. The susceptor 30 may be surrounded by the pipe 22. The susceptor body 31 may catch on the upper surface of the flange 50, or may be supported thereby.

A leg 35 may be formed at the lower end of the susceptor 30. The leg 35 may be formed by bending the lower portion of the susceptor 30 outwards. The leg 35 may be one of a plurality of legs. The legs 35 may catch on the lower surface of the flange 50, or may be supported thereby. The flange 50 may be disposed or fitted between the susceptor body 31 and the leg 35.

The susceptor 30 may have a hollow shape that is open at the lower end thereof. The sensing device 40 may be inserted into the susceptor 30. The sensing device 40 may include at least one of a temperature sensor 41, a conductive pin 42, or a sensor cover 43. The temperature sensor 41 may be disposed in the cavity in the susceptor 30. The temperature sensor 41 may sense the temperature of the susceptor 30. The temperature sensor 41 may be electrically connected to the conductive pin 42. The conductive pin 42 may be one of a plurality of conductive pins. The conductive pin 42 may include a pair of conductive pins. The temperature sensor 41 may be connected to the battery 11 and the controller 12 via the conductive pin 42. The sensor cover 43 may plug the lower open end of the susceptor 30. The sensor cover 43 may be bonded to the lower open end of the susceptor 30. The temperature sensor 41 may be coupled to the sensor cover 43. The conductive pin 42 may be exposed to the outside of the susceptor 30 through the sensor cover 43.

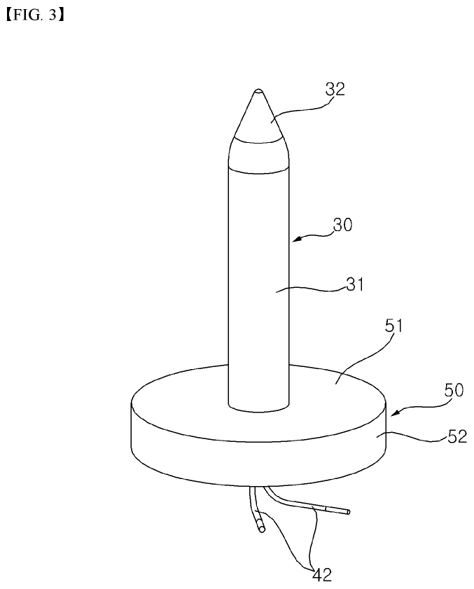

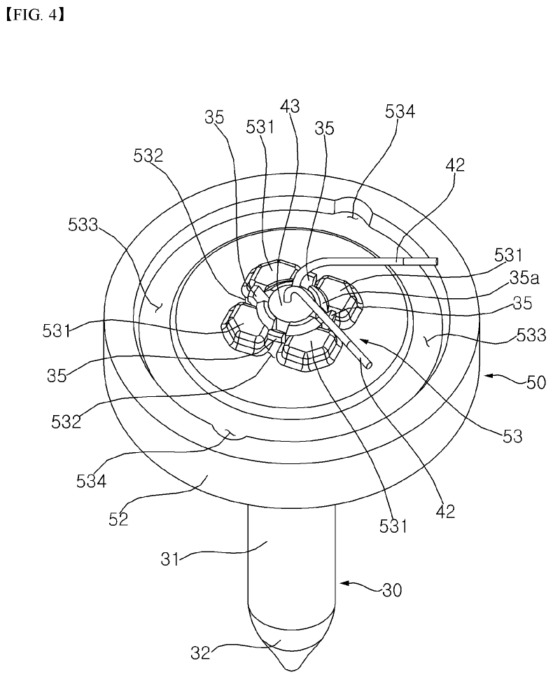

Referring to FIGS. 3 and 4, the flange 50 may take the form of a disc having a hole in the center thereof. Each of the one surface 51 and the other surface 53 of the flange 50 may have the shape of a circle. The outer circumferential surface 52 of the flange 50 may be connected both to the one surface 51 and to the other surface 53 of the flange 50, and may have a strip shape extending circumferentially. The outer circumferential surface 52 of the flange 50 may be in close contact with the inner circumferential surface of the lower portion of the pipe 22 in order to achieve a seal (see FIG. 2).

The susceptor 30 may extend lengthwise through the flange 50. One side of the susceptor 30 may be exposed at the one surface 51 of the flange 50. The other side of the susceptor 30 may be exposed at the other surface 53 of the flange 50. The susceptor body 31 and the susceptor head 32 may be formed at the one side of the susceptor 30. The leg may be formed at the other side of the susceptor 30. The one side of the susceptor 30 or the susceptor body 31 may be supported by the one surface 51 of the flange 50. The other side of the susceptor 30 or the leg 35 may be supported by the other surface 53 of the flange 50.

A retainer 531 and 532 may be formed at the flange 50 adjacent to the other end of the susceptor 30. The leg 35 may be supported by the retainer 531 and 532. The retainer 531 and 532 may be formed on the other surface 53 of the flange 50. The retainer 531 and 532 may include a retainer protrusion 531. The retainer 531 and 532 may include a retainer groove 532.

The retainer protrusion 531 may project to the other side from the other surface 53 of the flange 50. The retainer protrusion 531 may be formed around the other side of the susceptor 30 or the leg 35. The retainer protrusion 531 may be one of a plurality of retainer protrusions. The plurality of retainer protrusions 531 may be spaced apart from each other. The plurality of retainer protrusions 531 may be arranged around the other side of the susceptor 30 or the leg 35. The plurality of retainer protrusions 531 may be radially arranged about the other side of the susceptor 30.

The retainer groove 532 may be formed in the other surface 53 of the flange 50. The retainer groove 532 may be formed between two adjacent retainer protrusions 531. Alternatively, the retainer groove 532 may be formed by depressing the other surface 53 of the flange 50 in one direction. The retainer groove 532 may be formed around the other side of the susceptor 30 or the leg 35. The retainer groove 532 may be one of a plurality of retainer grooves. The plurality of retainer grooves 532 may be spaced apart from each other. The plurality of retainer grooves 532 may be arranged around the other side of the susceptor 30 or the leg 35. The plurality of retainer grooves 532 may be radially arranged about the other side of the susceptor 30.

The leg 35 may be formed by bending the other end 35a of the susceptor 30 in a radially outward direction. The leg 35 may be one of a plurality of legs. The legs 35 may be arranged circumferentially. The legs 35 may be radially arranged about the other side of the susceptor 30. The legs 35 may be formed at locations corresponding to the retainer grooves 532. The legs 35 may be disposed in retainer grooves 532. Each of the legs 35 may be disposed in a corresponding one of the plurality of retainer grooves 532. The legs may catch on respective retainer protrusions 531. Each leg 35 may be disposed between two adjacent retainer protrusions 531.

Accordingly, when the stick 200 (see FIG. 1) is inserted into or separated from the aerosol-generating device, it is possible to prevent the susceptor 30 from rotating with respect to the flange 50. Furthermore, it is possible to prevent the conductive pin 42 connected to the temperature sensor 41 from being entangled or cut due to rotation of the susceptor 30. In addition, it is possible to prevent separation of the susceptor 30 from the flange 50.

The other surface 53 of the flange 50 may be depressed in one direction so as to form a first depressed portion 533. The first depressed portion 533 may extend circumferentially. The first depressed portion 533 may be positioned further outwards than the retainer protrusion 531 and the retainer groove 532. The first depressed portion 533 may have the shape of a ring.

The first depressed portion 533 may be enlarged outwards so as to form a second depressed portion 534. The second depressed portion 534 may be formed in the other surface 53 of the flange 50. The second depressed portion 534 may be connected to the first depressed portion 533. The second depressed portion 534 may have a shape that is convex outwards from the first depressed portion 533. The second depressed portion 534 may be one of a plurality of second depressed portions. The plurality of second depressed portions 534 may be symmetrically positioned with respect to the susceptor 30.

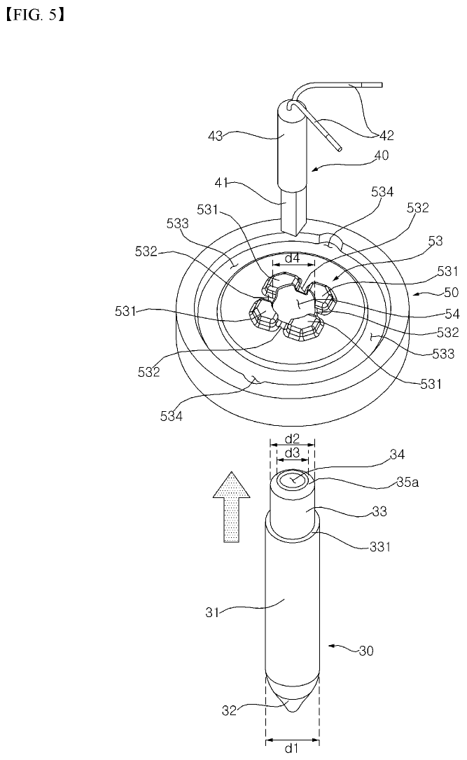

Referring to FIG. 5, the susceptor 30 may include a recessed portion 33. The recessed portion 33 may be formed in the other side of the susceptor 30. The recessed portion 33 may be formed by depressing the outer circumferential surface of the susceptor body 31 in a radially inward direction. The diameter d2 of the recessed portion 33 may be smaller than the diameter d1 of the susceptor body 31. The recessed portion 33 may be formed between the susceptor body 31 and the other end 35a of the susceptor 30. The recessed portion 33 and the susceptor body 31 may be coaxially aligned.

The other end 35a of the susceptor 30 may be connected to the recessed portion 33. The other end 35a of the susceptor 30 may have a form that gradually narrows moving toward the other side from the recessed portion 33. The other end 35a of the susceptor 30 may have the form of a truncated cone or a truncated body. The diameter d3 of the edge of the other end 35a of the susceptor 30 may be smaller than the diameter d2 of the recessed portion 33. The other end 35a of the susceptor 30 may be open so as to form a susceptor hole 34. The susceptor hole 34 may communicate with the cavity in the susceptor 30.

A retainer surface 331 may be formed between the recessed portion 33 and the susceptor body 31. The retainer surface 331 may extend radially outwards toward the end of the outer circumferential surface of the susceptor body 31 from the end of the outer circumferential surface of the recessed portion 33. The retainer surface 331 may be formed in the shape of a ring. The retainer surface 331 may project further than the recessed portion 33. The retainer surface 331 may be formed in a direction intersecting the longitudinal direction of the recessed portion 33 and the susceptor body 31.

A through hole 54 may be formed through the center of the flange 50. The inner circumferential surface of the flange 50 may surround the side portion of the through hole 54. The retainer protrusion 531 and the retainer groove 532 may be formed around the through hole 54. The through hole 54 may formed so as to have a cylindrical form. The through hole 54 may extend from the one surface 51 (see FIG. 3) of the flange 50 to the other surface 53 thereof.

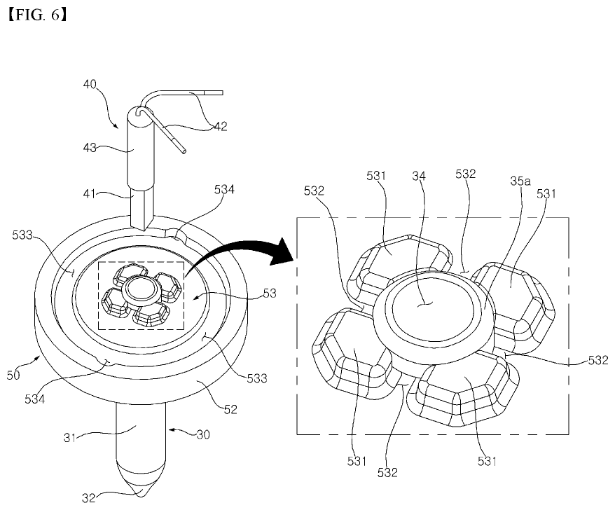

Referring to FIGS. 5 and 6, the diameter d2 of the recessed portion 33 may be larger than the diameter d4 of the through hole 54. The diameter d3 of the other end 35a of the susceptor 30 may be smaller than the diameter d4 of the through hole 54. The diameter d1 of the susceptor body 31 may be larger than the diameter d2 of the recessed portion 33 and the diameter d4 of the through hole 54.

The susceptor 30 may extend through the through hole 54 in the flange 50. The susceptor 30 may be inserted into the through hole 54 from the one surface 51 (see FIG. 3) of the flange 50 toward the other surface 53 thereof. The susceptor 30 may be inserted into the through hole 54 from the other end of the susceptor 30. The other end 35a of the susceptor 30 may be inserted into the through hole 54 in the state in which the leg 35 (see FIG. 4) is not formed.

When the susceptor 30 is inserted into the through hole 54, the sloping surface of the other end 35a may be inserted into the through hole 54 while sliding on the inner circumferential surface of the flange 50. The other end 35a of the susceptor 30 may extend through the through hole 54, and may be exposed at the other surface 53 of the flange 50. The flange 50 may be made of an elastic material. For example, the flange 50 may be made of plastic.

After the other end 35a of the susceptor 30 passes through the through hole 54, the recessed portion 33 may be inserted into the through hole 54. The recessed portion 33 may be forcibly fitted into the through hole 54 in the flange 50. The diameter d4 of the through hole 54 may be set to have dimensions such that the recessed portion 33 is capable of being inserted into the through hole 54 but the susceptor body 31 is incapable of being inserted into the through hole 54. The inner circumferential surface of the flange 50 may surround the outer circumferential surface of the recessed portion 33 in the state of being in close contact therewith.

The retainer surface 331 may catch on the one surface 51 of the flange 50, and thus may not pass through the through hole 54 (see FIG. 3). The retainer surface 331 may be supported by the one surface 51 of the flange 50 (see FIG. 3).

Consequently, it is possible to seal the gap in the through hole 54 between the susceptor 30 and the flange 50, and it is possible to prevent liquid from leaking between the susceptor 30 and the flange 50.

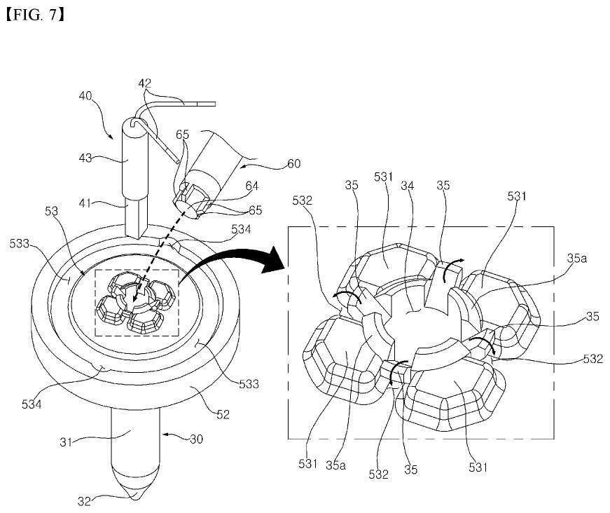

Referring to FIGS. 6 and 7, after the other end 35a of the susceptor 30 is exposed at the other surface 53 of the flange 50, the other end 35a of the susceptor 30 may be bent radially outwards so as to form the leg 35. The other end 35a of the susceptor 30 may be formed so as to have a small thickness. The susceptor 30 may be made of metal, which has a certain rigidity but is sufficiently thin so as to be easily torn. For example, the susceptor 30 may be made of stainless steel.

A presser 60 may include a presser body 64 and a bit blade 65. The bit blade 65 may project radially outwards from the outer circumferential surface of the presser body 64. The presser 60 may include a number of bit blades 65 corresponding to the number of legs to be formed. The bit blades 65 may include a number of bit blades corresponding to the number of retainer grooves 532. The bit blades 65 may be radially arranged about the presser body 64. The presser body 64 may have the form of a cylinder. The diameter of the presser body 64 may be smaller than or similar to the diameter of the susceptor hole 34. The presser body 64 may be inserted into the susceptor hole 34. The bit blades 65 may be formed so as to be gradually widened in a direction opposite the direction in which the presser 60 is inserted.

The leg 35 may be formed by pressing the other end 35a of the susceptor 30 around the susceptor hole 34 using the presser 60. The presser 60 may have rigidity higher than that of the susceptor 30. When the presser body 64 is inserted into the susceptor hole 34, the bit blades 65 may press the other end 35a of the susceptor 30. When the bit blades 65 press the other end 35a of the susceptor 30, the other end 35a of the susceptor 30 may be bent outwards while being torn, thereby forming the legs 35. The portions of the other end of the susceptor 30 at which the legs 35 are not formed are supported by the retainer protrusions 531, whereby the portions of the other end 35a may be prevented from being torn or bent outwards. The susceptor hole 34 may enable the other end 35a of the susceptor to be easily bent outwards.

Each of the plurality of legs 35 may be bent radially outwards, and may thus be disposed in a corresponding one of the plurality of retainer grooves 532. The legs 35 may extend in a direction intersecting the longitudinal direction of the susceptor 30. The other surface 53 of the flange 50 may support the legs 35. Each of the legs 35 may be disposed in a corresponding retainer groove 532 between a pair of adjacent retainer protrusions 531. The pair of retainer protrusions 531 may be disposed at or in close contact with the two lateral side portions of the leg 35.

Accordingly, it is possible to prevent the susceptor 30 from rotating with respect to the flange 50 when the stick 200 (see FIG. 1) is inserted into or separated from the aerosol-generating device. Furthermore, it is possible to prevent the susceptor 30 from being separated from the flange 50 by fixing the susceptor 30 to the flange 50 in a simple manner.

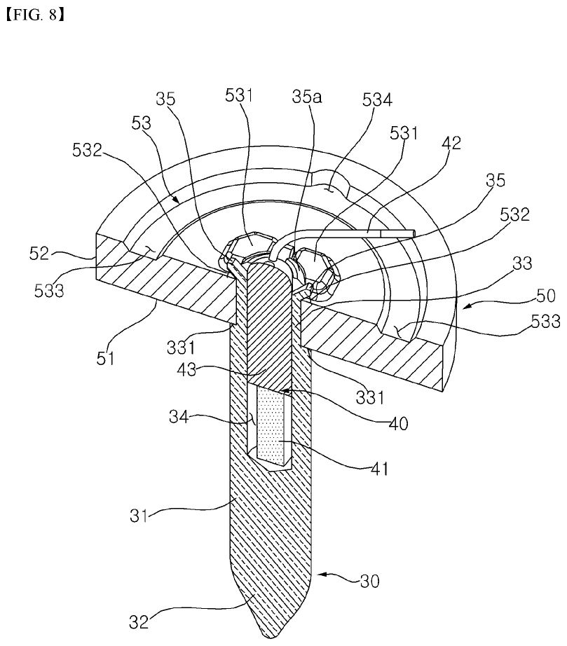

Referring to FIGS. 7 and 8, the sensing device 40 may be inserted into the susceptor through the susceptor hole 34. The sensing device 40 may be inserted into the susceptor after the legs 35 are formed. The temperature sensor 41 may be inserted into the susceptor 30, and the sensor cover 43 may plug the susceptor hole 34. The sensor cover 43 may be bonded to the susceptor 30. The conductive pin 42 connected to the temperature sensor 41 may be exposed to the outside of the susceptor 30 through the sensor cover 43.

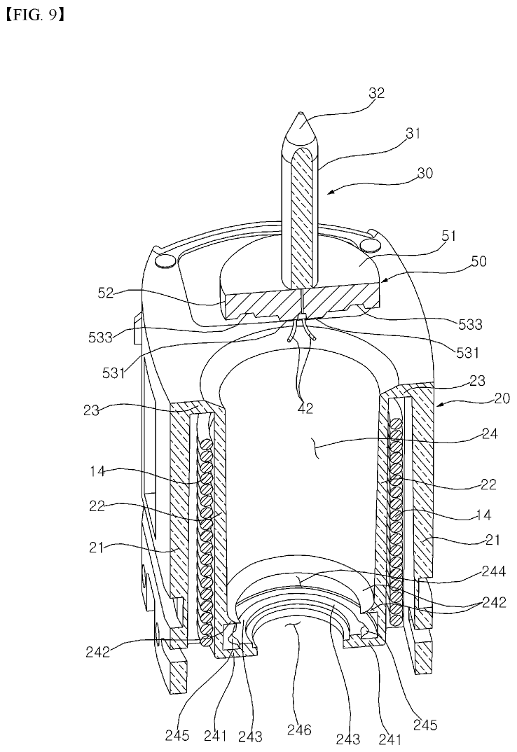

Referring to FIG. 9, the first rib 241 and the second rib 242 may project radially inwards from the inner circumferential surface of the lower portion of the pipe 22. Each of the first rib 241 and the second rib 242 may have the shape of a ring. The first rib 241 may be formed at the lower end of the pipe 22. The second rib 242 may be formed at the lower portion of the pipe 22 above the first rib 241. A rib hole 246 may be formed by perforating the center of the first rib 241.

The flange 50 may be disposed in the mount space 244 defined between the first rib 241 and the second rib 242. The flange 50 may be forcibly fitted into the mount space 244, or may be insert-molded in the mount space 244. The first rib 241 may cover the periphery of the other surface 53 of the flange 50 in the state of being in close contact therewith. The outer circumferential surface of the flange 50 may be in close contact with the inner circumferential surface of the pipe 22 in the mount space 244 defined between the first rib 241 and the second rib 242. The other side of the susceptor 30, the conductive pin 42, the retainer protrusion 531, and the retainer groove 532 may be exposed through the rib hole 246.

A first projection 243 may be formed so as to project upwards from the first rib 241. The first projection 243 may circumferentially extend along the shape of the first rib 241. The first projection 243 may have a shape corresponding to the first depressed portion 533. The first projection 243 may be formed in the shape of a ring. The first projection 243 may be spaced inwards apart from the inner circumferential surface of the pipe 22. The first projection 243 may be inserted or forcibly fitted into the first depressed portion 533.

A second projection 245 may project outwards from the first projection 243. The second projection 245 may be connected to the first projection 243. The second projection 245 may have a shape that is convex outwards from the first projection 245. The second projection 245 may be one of a plurality of second projections. Each of the plurality of second projections 245 may have a shape corresponding to one of the second depressed portions 534. The second projections 245 may be inserted or forcibly fitted into respective second depressed portions 534.

Accordingly, it is possible to prevent the flange 50 from rotating with respect to the pipe 22. Furthermore, it is possible to prevent the flange 50 from being separated from the pipe 22.

Referring to FIGS. 1 to 17, an aerosol-generating device 100 according to one aspect of the present disclosure includes a pipe 22 defining an insertion space 24, a flange 50 comprising a through hole and coupled to the pipe 22 at a first side of the insertion space 24, and a susceptor 30 extending through the through hole 54 such that a first end thereof extends into the insertion space 24, wherein a leg 35 of the susceptor 30 at a second end 35a thereof bent radially outwards and configured to engage with a retainer 531 and 532 formed at the flange 50.

In addition, according to another aspect of the present disclosure, the susceptor 30 may include a susceptor body 31, disposed in the insertion space 24, and a recessed portion 33 formed between the susceptor body 31 and the leg 35 and configured to be secured in the through hole 54, wherein a first side of the flange 50 supports the susceptor body 31 and a second side of the flange 50 opposite the first side supports the leg 35 of the susceptor 30.

In addition, according to another aspect of the present disclosure, the leg 35 may be formed by inserting the second end of the susceptor 30 through the through hole 54 and bending outward a portion of the second end 35a of the susceptor 30 protruding from the second side of the flange 50.

In addition, according to another aspect of the present disclosure, a diameter of the through hole 54 may be smaller than the diameter of the recessed portion 33 such that the recessed portion 33 is secured in the through hole 54 in an interference-fit manner.

In addition, according to another aspect of the present disclosure, the second end 35a of the susceptor 30 may have a portion formed obliquely to be gradually narrowed toward a direction in which the susceptor 30 is inserted into the through hole such 54 that the recessed portion 33 is inserted into the through hole 54.

In addition, according to another aspect of the present disclosure, the second end 35a of the susceptor 30 for insertion into the through hole 54, may have a portion at a tip of the second end 35a having a diameter which is smaller than the diameter of the through hole 54 and the diameter of the recessed portion 33.

In addition, according to another aspect of the present disclosure, the leg 35 may be formed at the second portion of after the susceptor 30 protruding from the through hole by passing through the through hole 54.

In addition, according to another aspect of the present disclosure, the susceptor 30 may comprise a susceptor hole 34 formed at the second end 35a.

In addition, according to another aspect of the present disclosure, the retainer 531 and 532 may be one of a plurality of retainer protrusions 531 projecting from the flange 50 surrounding the through hole 54 and a retainer groove 532 formed between two respective retainer protrusions 531, wherein the leg 35 is disposed in the retainer groove 532.

In addition, according to another aspect of the present disclosure, the retainer 531 and 532 may comprise a plurality of the retainer grooves 532 and the leg 35 may be one of be one of a plurality of legs 35, wherein the plurality of retainer grooves 532 and plurality of legs 35 are correspondingly may be arranged circumferentially with respect to the through hole 54.

In addition, according to another aspect of the present disclosure, the susceptor 30 may comprise a cavity having an opening formed at the second end, and the aerosol-generating device may further include a sensing device disposed in the cavity and configured to sense the temperature of the susceptor 30.

In addition, according to another aspect of the present disclosure, the susceptor 30 may be cylindrical.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
a pipe defining an insertion space;
a flange comprising a through hole and coupled to the pipe at a first side of the insertion space; and
a susceptor extending through the through hole such that a first end thereof extends into the insertion space;
wherein a leg of the susceptor at a second end thereof is bent radially outwards and configured to engage with a retainer formed at the flange.

2. The aerosol-generating device according to claim 1, wherein the susceptor comprises:
a susceptor body disposed in the insertion space; and
a recessed portion formed between the susceptor body and the leg and configured to be secured in the through hole,
wherein a first side of the flange supports the susceptor body and a second side of the flange opposite the first side supports the leg of the susceptor.

3. The aerosol-generating device according to claim 2, wherein
wherein the leg is formed by inserting the second end of the susceptor through the through hole and bending outward a portion of the second end of the susceptor protruding from the second side of the flange.

4. The aerosol-generating device according to claim 2, wherein a diameter of the through hole is smaller than a diameter of the recessed portion such that the recessed portion is secured in the through hole in an interference-fit manner.

5. The aerosol-generating device according to claim 4, wherein the second end of the susceptor has a portion formed obliquely to be gradually narrowed toward a direction in which the susceptor is inserted into the through hole such that the recessed portion is inserted into the through hole.

6. The aerosol-generating device according to claim 5, wherein the second end of the susceptor for insertion into the through hole, has a portion at a tip of the second end having a diameter which is smaller than the diameter of the through hole and the diameter of the recessed portion.

7. The aerosol-generating device according to claim 2, wherein the leg is formed at the second portion of the susceptor protruding from the through hole by passing through the through hole.

8. The aerosol-generating device according to claim 7, wherein the susceptor comprises a susceptor hole formed at the second end.

9. The aerosol-generating device according to claim 1, wherein the retainer comprises:
a plurality of retainer protrusions projecting from the flange surrounding the through hole; and
a retainer groove formed between two respective retainer protrusions,
wherein the leg is disposed in the retainer groove.

10. The aerosol-generating device according to claim 1, wherein the retainer comprises a plurality of retainer grooves and the leg is one of a plurality of legs, and
wherein the plurality of retainer grooves and plurality of legs are correspondingly arranged circumferentially with respect to the through hole.

11. The aerosol-generating device according to claim 1, wherein the susceptor comprises a cavity having an opening formed at the second end, and
wherein the aerosol-generating device further comprises a sensing device disposed in the cavity and configured to sense temperature of the susceptor.

12. The aerosol-generating device according to claim 1, wherein the susceptor is cylindrical.
